(19) United States
(12) Patent Application Publication
(10) Pub. No.: US 2025/0313208 A1
(43) Pub. Date: Oct. 9, 2025

(54) VEHICLE CONTROL APPARATUS AND METHOD THEREOF

(71) Applicants: Hyundai Motor Company, Seoul (KE); Kia Corporation, Seoul (KR)

(72) Inventors: Heung Seok Chae, Hwaseong-Si (KR); Ji Chang Kim, Hwaseong-Si (KR); Su Jung Yoo, Hwaseong-Si (KR); Yoo Suk Kim, Hwaseong-Si (KR)

(21) Appl. No.: 18/925,145

(22) Filed: Oct. 24, 2024

(30) Foreign Application Priority Data
Apr. 4, 2024 (KR) 10-2024-0046103

(51) Int. Cl. B60W 30/18

(52) U.S. Cl. CPC B60W 30/18163; B60W 2420/403; B60W 2554/4041; B60W 2554/802; B60W 2554/804

(57) ABSTRACT

An apparatus for controlling a vehicle may comprise a sensor, a memory storing at least one instruction, and a processor operatively coupled to the sensor and the memory. The instruction, when executed by the processor, is configured to determine, based on a lane characteristic and a driving path of the vehicle, whether to make a lane change. The characteristic and driving path are obtained using the sensor. Upon determining to make a lane change, the sensor detects another vehicle in a second lane adjacent to the first lane. The apparatus determines at least one target space between the vehicle and the other vehicle for the lane change, selects a specified target space based on arrival times and expected speed trajectory, and controls the vehicle to enter the specified target space and make the lane change based on the vehicle's relative position to the target space satisfying a condition.

### CROSS-REFERENCE TO RELATED APPLICATION

This application claims the benefit of priority to Korean Patent Application No. 10-2024-0046103, filed in the Korean Intellectual Property Office on Apr. 4, 2024, the entire contents of which are incorporated herein by reference.

### TECHNICAL FIELD

The present disclosure relates to a vehicle control apparatus and a method thereof, and more particularly, relates to technologies for safely and quickly controlling a host vehicle in a situation in which there is a need to make a lane change.

### BACKGROUND

The matters described in this Background section are only for enhancement of understanding of the background of the disclosure, and should not be taken as acknowledgement that they correspond to prior art already known to those skilled in the art.

As an autonomous driving control technology and/or a semi-autonomous driving control technology are/is developed, a stable driving technology for a host vehicle may gradually become more sophisticated. For example, there is a need to develop various algorithms for making a lane change or performing biased driving control, based on various environments, such as a driving situation in an adjacent lane and driving information of the host vehicle, if identifying a situation in which there is a need to make the lane change to the adjacent lane while performing driving control for the host vehicle.

For example, while performing driving control for the host vehicle, if a situation in which the point at which the lane is ended is not far away is identified or determined, a vehicle control apparatus may determine that there is a need for the host vehicle to make a lane change. There is a need to develop various algorithms for safely performing lane change control without colliding with other vehicles in the adjacent lane in such a situation.

Meanwhile, although it is identified that there is the need to make the lane change, if it is impossible to immediately make the lane change due to at least one other vehicle in the adjacent lane, a movement line and a time for controlling the host vehicle may be unnecessary wasted.

In addition or alternative, if selecting a target space for a lane change, a problem, such as collision with other vehicles which are traveling in the adjacent lane or collision with a follow vehicle which is traveling in the lane of the host vehicle, should be considered.

### SUMMARY

According to the present disclosure, an apparatus for controlling a vehicle, the apparatus may comprise a sensor, a memory storing at least one instruction, and a processor operatively coupled to the sensor and the memory, wherein the at least one instruction, when executed by the processor is configured to cause the apparatus to determine, based on a characteristic of a lane and a driving path of the vehicle, whether to make a lane change, wherein the characteristic and the driving path are obtained using the sensor, based on a determination to make the lane change, detect, using the sensor, at least one other vehicle in a second lane adjacent to a first lane in which the vehicle is traveling, determine at least one target space between the vehicle and the at least one other vehicle for the lane change, determine, based on at least one arrival time, a specified target space of the at least one target space, wherein each arrival time of the at least one arrival time is an expected time for the vehicle to arrive at a respective target space of the at least one target space, and wherein the expected time is determined based on an expected speed trajectory of the vehicle and a size of the respective target space of the at least one target space, and control, based on a relative position between the vehicle and the specified target space satisfying a condition, the vehicle to enter the specified target space and make the lane change.

The apparatus, wherein the at least one instruction, when executed by the processor, is configured to cause the apparatus to based on a presence of a point at which the first lane is ended within a specified distance of the first lane or based on a detected event that requires the vehicle to travel in the second lane, determine to make the lane change.

The apparatus, wherein the at least one instruction, when executed by the processor, is configured to cause the apparatus to determine, using the sensor, an average driving speed of the at least one other vehicle and determine, based on a difference between the average driving speed and a driving speed of the vehicle being less than or equal to a specified speed, the at least one target space.

The apparatus, wherein the at least one instruction is, when executed by the processor, is configured to cause the apparatus to determine, using the sensor, an average driving speed of the at least one other vehicle and adjust, based on a difference between the average driving speed and a driving speed of the vehicle being greater than a specified speed, the driving speed of the vehicle to follow the average driving speed.

The apparatus, wherein the at least one instruction, when executed by the processor, is configured to cause the apparatus to determine, based on acceleration control or deceleration control for the vehicle, the expected speed trajectory and determine, based on the expected speed trajectory, one of the at least one arrival time and the size of the specified target space at an arrival time point.

The apparatus, wherein the at least one instruction is, when executed by the processor, is configured to cause the apparatus to determine the expected speed trajectory based on at least one of a distance to a point at which the first lane is ended, a first driving speed limit in the first lane and a second driving speed limit in the second lane, a user input speed, or a separation distance between the vehicle and another vehicle.

The apparatus, wherein the at least one instruction, when executed by the processor, is configured to cause the apparatus to determine, using the sensor, a first driving speed of a first other vehicle which is present in front of the vehicle and a second driving speed of a second other vehicle which is present behind the vehicle, determine, based on the first driving speed and a driving speed of the vehicle, a rear margin of the first other vehicle, determine, based on the second driving speed, the driving speed of the vehicle, and a first length of the vehicle, and a second length of the second other vehicle, a front margin of the second other vehicle and determine a space between the rear margin and the front margin as one of the at least one target space.

The apparatus, wherein the at least one instruction, when executed by the processor, is configured to cause the apparatus to determine a target space with a smallest arrival time and a largest size among a plurality of target spaces as the specified target space.

The apparatus, wherein the at least one instruction, when executed by the processor, is configured to cause the apparatus to control, based on one point of the vehicle overtaking a starting point of the specified target space, the vehicle to enter the specified target space and make the lane change.

The apparatus, wherein the at least one instruction, when executed by the processor, is configured to cause the apparatus to control, based on one point of the vehicle not overtaking a starting point of the specified target space, the vehicle to perform biased driving to be adjacent to the second lane.

According to the present disclosure, a method performed by an apparatus of a vehicle for controlling the vehicle, the method may comprise determining, based on a characteristic of a lane and a driving path of the vehicle, whether to make a lane change, wherein the characteristic and the driving path are obtained using a sensor, based on a determination to make the lane change, detecting, using the sensor, at least one other vehicle in a second lane adjacent to a first lane in which the vehicle is traveling, determining at least one target space between the vehicle and the at least one other vehicle for the lane change, determining, based on at least one arrival time, a specified target space of the at least one target space, wherein each arrival time of the at least one arrival time is an expected time for the vehicle to arrive at a respective target space of the at least one target space, and wherein the expected time is determined based on an expected speed trajectory of the vehicle and a size of the respective target space of the at least one target space, and controlling, based on a relative position between the vehicle and the specified target space satisfying a specified condition, the vehicle to enter the specified target space and make the lane change.

The method may further comprise based on a presence of a point at which the first lane is ended within a specified distance of the first lane or based on a detected event that requires the vehicle to travel in the second lane, determining to make the lane change.

The method may further comprise determining, using the sensor, an average driving speed of the at least one other vehicle, and determining, based on a difference between the average driving speed and a driving speed of the vehicle being less than or equal to a specified speed, the at least one target space.

The method may further comprise determining, using the sensor, an average driving speed of the at least one other vehicle, and adjusting, based on a difference between the average driving speed and a driving speed of the vehicle being greater than a specified speed, the driving speed of the vehicle to follow the average driving speed.

The method may further comprise determining, based on acceleration control or deceleration control for the vehicle, the expected speed trajectory, and determining, based on the expected speed trajectory, one of the at least one arrival time and the size of the specified target space at an arrival time point.

The method may further comprise determining the expected speed trajectory based on at least one of a distance to a point at which the first lane is ended, a first driving speed limit in the first lane and a second driving speed limit in the second lane, a user input speed, or a separation distance between the vehicle and another vehicle.

The method may further comprise determining, using the sensor, a first driving speed of a first other vehicle which is present in front of the vehicle and a second driving speed of a second other vehicle which is present behind the vehicle, determining, based on the first driving speed and a driving speed of the vehicle, a rear margin of the first other vehicle, determining, based on the second driving speed, the driving speed of the vehicle, and a first length of the vehicle and a second length of the second other vehicle, a front margin of the second other vehicle, and determining a space between the rear margin and the front margin as one of the at least one target space.

The method may further comprise determining a target space with a smallest arrival time and a largest size among a plurality of target spaces as the specified target space.

The method may further comprise controlling, based on one point of the vehicle overtaking a starting point of the specified target space, the vehicle to enter the specified target space and make the lane change.

The method may further comprise controlling, based on one point of the vehicle not overtaking a starting point of the specified target space, the vehicle to perform biased driving to be adjacent to the second lane.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of components of a vehicle control apparatus according to an example of the present disclosure;

FIG. 2 shows an example of components and an operation of a vehicle control apparatus according to an example of the present disclosure;

FIG. 3 shows an example of a situation in which a host vehicle is traveling according to an example of the present disclosure;

FIG. 4 shows an example of an operation of identifying a target space in a vehicle control apparatus according to an example of the present disclosure;

FIG. 5 shows an example of an operation of identifying a target space in a vehicle control apparatus according to an example of the present disclosure;

FIG. 6A shows an example of a situation in which a vehicle control apparatus determines a condition for making a lane change according to an example of the present disclosure;

FIG. 6B shows an example of a situation in which a vehicle control apparatus determines a condition for making a lane change according to an example of the present disclosure;

FIG. 7 shows an example of a vehicle control method according to an example of the present disclosure;

FIG. 8 shows an example of a vehicle control method according to an example of the present disclosure; and

FIG. 9 shows an example of a computing system about a vehicle control apparatus or a vehicle control method according to an example of the present disclosure.

With regard to description of drawings, the same or similar denotations may be used for the same or similar components.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even when they are displayed on other drawings. In addition or alternative, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

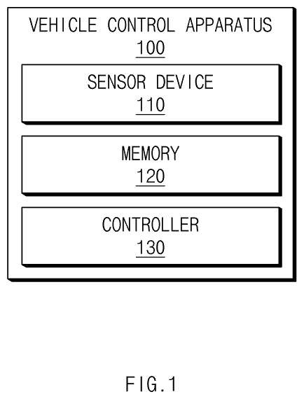

Hereinafter, examples of the present disclosure will be described in detail with reference to FIGS. 1 to 9.

FIG. 1 shows an example of components of a vehicle control apparatus according to an example of the present disclosure.

According to an example, a vehicle control apparatus 100 may include a sensor device 110 (e.g., a radio detection and ranging (RADAR), a light detection and ranging (LiDAR), camera, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, etc.), a memory 120, and/or a controller 130 (e.g., processor circuit). The components of the vehicle control apparatus 100, which are shown in FIG. 1, are illustrative, and examples of the present disclosure are not limited thereto. For example, the vehicle control apparatus 100 may further include components (e.g., at least one of a communication device, an interface, a display, or a notification device, or any combination thereof) which are not shown in FIG. 1.

According to an example, the sensor device 110 may obtain (or sense) various pieces of information used for driving of a host vehicle.

For example, the sensor device 110 may include at least one sensor including at least one of a camera, radio detection and ranging (RADAR), or light detection and ranging (LiDAR), or any combination thereof.

For example, the sensor device 110 may obtain information about an external object (e.g., at least one of a person, a lane, an adjacent lane, another vehicle, a building, or a structure, or a combination thereof), using the at least one sensor.

For example, the sensor device 110 may obtain information (e.g., object detection, distance measurement, 3D mapping, object shape and size, speed and direction of objects, road surface conditions, lane marking detection, surrounding environment geometry, environmental obstacles, road edges and boundaries, traffic signal and sign detection, or weather condition assessment, etc.) about a driving environment of the host vehicle. As an example, the sensor device 110 may obtain information about at least one of a driving speed of the host vehicle, acceleration of the host vehicle, or a driving direction of the host vehicle, or any combination thereof.

For example, the sensor device 110 may obtain information about whether there is at least one other vehicle and/or a driving state of the at least one other vehicle (e.g., at least one of a driving speed of the at least one other vehicle, acceleration of the at least one other vehicle, a driving direction of the at least one other vehicle, a separation distance from the host vehicle, or whether the at least one other vehicle is stopped, or a combination thereof). As an example, the at least one other vehicle may include at least one other vehicle which is traveling in a lane in which the host vehicle is traveling and an adjacent lane of the lane. The sensor device 110 may divide and identify, detect, or determine, for example, at least one other vehicle which is traveling in front of the host vehicle and at least one other vehicle which is traveling behind the host vehicle. The sensor device 110 may identify, for example, a length of the at least one other vehicle.

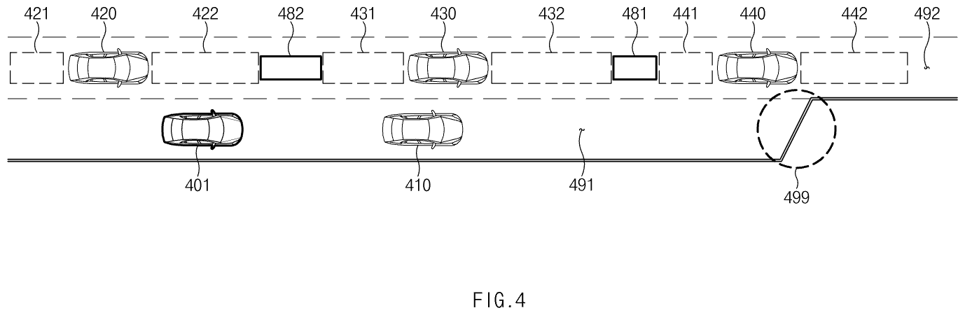

For example, the sensor device 110 may obtain a characteristic of the lane (e.g., lane width, lane type, lane markings, lane curvature, lane position, lane merging points, lane grade, lane direction, lane condition, or lane visibility, etc.) in which the host vehicle is traveling. As an example, the characteristic of the lane may include information about a point (e.g., an end point 499 of FIG. 4) at which the lane is ended (or finished). As an example, the characteristic of the lane may include at least one of a position of a line of the lane, a separation distance between the host vehicle and the line, or a width of the lane, or any combination thereof.

For example, the controller 130 may identify an average driving speed of the at least one other vehicle which is driving in the adjacent lane, based on the information obtained using the sensor device 110.

According to an example, the memory 120 may store a command or data. For example, the memory 120 may store one or more instructions, when executed by the controller 130, causing the vehicle control apparatus 100 to perform various operations.

For example, the memory 120 and the controller 130 may be implemented as one chipset. The controller 130 may include at least one of a communication processor or a modem.

For example, the memory 120 may store various pieces of information associated with the vehicle control apparatus 100. As an example, the memory 120 may store information about an operation history of the controller 130. As an example, the memory 120 may store information associated with states and/or operations of components (e.g., at least one of an engine control unit (ECU), the sensor device 110, or the controller 130, or any combination thereof) of the host vehicle.

For example, the memory 120 may include different types of a plurality of storage devices (e.g., a random-access memory (RAM), an embedded multi-media card (eMMC), a data scratch pad RAM (DSPR), a data local memory unit (DLMU), a local memory unit (LMU), or a default application memory (DAM), etc.). For example, the memory 120 may include at least one of a random-access memory (RAM) or an embedded multi-media card (eMMC), or any combination thereof.

As an example, the RAM may temporarily store data (e.g., driving data) about an operation of the autonomous control apparatus 100 and/or the host vehicle which is a control target of the autonomous control apparatus 100. The RAM may include, for example, at least one buffer. The autonomous control apparatus 100 may store, for example, at least one node divided by dividing pieces of data collected (or identified) while performing driving control for the host vehicle by a unit time in the RAM.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver if the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

As an example, the eMMC may include a built-in multimedia card. The eMMC may store, for example, data for a longer duration than the RAM. The eMMC may be implemented as, for example, a separate memory chip independent of the RAM.

According to an example, the controller 130 may be operatively connected with the sensor device 110 and/or the memory 120. For example, the controller 130 may control operations of the sensor device 110 and/or the memory 120.

For example, the controller 130 may obtain a characteristic of the lane and a driving path of the host vehicle using the sensor device 110.

As an example, the controller 130 may identify a point at which the lane in which the host vehicle is traveling is ended, using the sensor device 110.

As an example, the controller 130 may obtain a driving path using the sensor device 110. The driving path may be, for example, an expected path to a destination defined by a setting of a user. The controller 130 may obtain (or identify) a driving path using pieces of driving information (e.g., a driving state of the host vehicle, a state of the road, shortest path information to the destination, or the like) obtained using the sensor device 110.

For example, the controller 130 may identify whether there is a need to make a lane change, based on the characteristic of the lane and the driving path.

As an example, if there is a point at which the lane is ended within a specified distance of the lane in which the host vehicle is traveling, the controller 130 may identify that there is the need to make the lane change. In other words, if there is the point at which the lane is ended within the specified distance, with respect to a current position of the host vehicle, the controller 130 may determine that there is the need to make the lane change to an adjacent lane.

As an example, if identifying or determining the situation of having the host vehicle to travel to the adjacent lane based on the driving path, the controller 130 (e.g., processor circuit) may identify that there is the need to make the lane change. In other words, if identifying a situation in which the host vehicle needs to make a left turn or a right turn based on the driving path or checking that the host vehicle should travel in another lane because there is an intersection in front of the host vehicle, the controller 130 may determine that there is the need to make the lane change.

For example, if it is determined that there is the need to make the lane change, the controller 130 may identify at least one other vehicle in the adjacent lane adjacent to the lane in which the host vehicle is traveling, using the sensor device 110.

As an example, the controller 130 may identify or determine an average driving speed of the at least one other vehicle which is traveling in the adjacent lane.

As an example, the controller 130 may identify or determine a relative position between the host vehicle and the at least one other vehicle. For example, the controller 130 may identify or determine a first other vehicle which is traveling in front of the host vehicle and a second other vehicle which is traveling behind the host vehicle on the adjacent lane.

For example, the controller 130 may identify or determine at least one target space for a lane change between the at least one other vehicle.

As an example, only if driving states of the host vehicle and the at least one other vehicle meet a specific condition, the controller 130 may identify or determine the at least one target space. For example, the controller 130 may identify an average driving speed of the at least one other vehicle and may identify the at least one target space, only if a difference between the average driving speed and the driving speed of the host vehicle satisfying (e.g., the difference is less than or equal to a specified speed) a specified speed. As an example, if the difference between the average driving speed and the driving speed of the host vehicle does not satisfy (e.g., the difference is greater than the specified speed) the specified speed, the controller 130 may adjust or change the driving speed of the host vehicle to follow the average driving speed.

As an example, the controller 130 may identify at least a portion of a space between the at least one other vehicle and the host vehicle as the at least one target space.

As an example, the controller 130 may identify a first driving speed of the first other vehicle which is present in front (e.g., leading, pulling away, slowing down, stopping, braking, cruising, changing lanes, blocking, signaling, or accelerating, etc.) of the host vehicle among the at least one other vehicle and a second driving speed of the second other vehicle which is present behind (e.g., tailgating, maintaining a safe distance, following closely, trailing, in pursuit, shadowing, approaching, lining up behind, closing the gap, or staying in the wake, etc.) the host vehicle among the at least one other vehicle. The controller 130 may identify, for example, a rear margin of the first other vehicle using the first driving speed and the driving speed of the host vehicle. The controller 130 may identify, for example, a front margin of the second other vehicle using the second driving speed, the driving speed of the host vehicle, and lengths of the host vehicle and the second other vehicle. The controller 130 may identify, for example, a space between the identified rear margin of the first other vehicle and the identified front margin of the second other vehicle as one of the at least one target space. In this manner, the controller 130 may identify a space except form a margin among spaces between the at least one other vehicle as the at least one target space.

As an example, if a frontmost vehicle among the at least one other vehicle which is traveling in the adjacent lane is identified, a space after a front margin of the frontmost vehicle may be identified as an entire target space.

As an example, if a rearmost vehicle among the at least one other vehicle which is traveling in the adjacent lane is identified, a space after a rear margin of the rearmost vehicle may be identified as an entire target space.

For example, the controller 130 may identify a specified target space based on an arrival time for each of the at least one target space expected to arrive based on an expected speed trajectory of the host vehicle and a size of each of the at least one target space.

As an example, the controller 130 may identify the expected speed trajectory calculated assuming that acceleration control or deceleration control is performed for the host vehicle. The acceleration control and/or deceleration control may include, for example, a driving control algorithm based on acceleration and/or deceleration preset by the user.

As an example, the controller 130 may identify the expected speed trajectory by further using a speed condition, a distance condition, or the like according to a driving environment. The controller 130 may identify, for example, the expected speed trajectory meeting a condition about at least one of a distance to the point at which the lane is ended, a driving speed limit in the lane and the adjacent lane, a user input speed, or a separation distance between the host vehicle and a forward other vehicle, or any combination thereof.

For example, if the host vehicle makes a lane change based on the expected speed trajectory, the controller 130 may identify the expected speed trajectory with regard to whether the lane change is completed before the point at which the lane is ended.

For example, the controller 130 may identify the expected speed trajectory in which a maximum value of the speed according to the expected speed trajectory is set to the driving speed limit in the lane and the adjacent lane or less.

For example, if the host vehicle makes a lane change based on the expected speed trajectory, the controller 130 may identify the expected speed trajectory in which a difference between the user input speed and the driving speed of the host vehicle is maintained as being less than or equal to a specified difference.

For example, if the host vehicle makes a lane change based on the expected speed trajectory, the controller 130 may identify the expected speed trajectory, such that the host vehicle and the forward other vehicle do not collide with each other.

As an example, the controller 130 may identify an arrival time to arrive at each of the at least one target space, based on the expected speed trajectory. The arrival time may be, for example, a time expected to arrive at the at least one target space if the host vehicle drives along the expected speed trajectory from the current position.

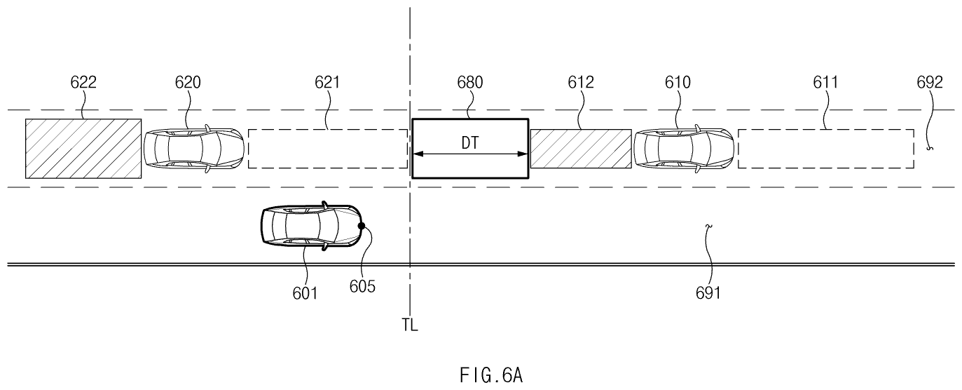

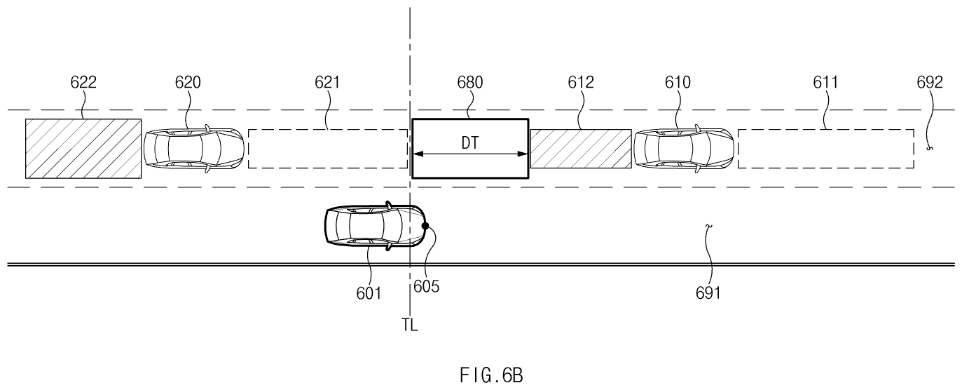

As an example, the controller 130 may identify a size of each of the at least one target space at a time point expected to arrive at each of the at least one target space, based on the expected speed trajectory. The size of the target space may indicate, for example, a horizontal length (e.g., a length DT of FIG. 6A) and/or a vertical length with respect to a top view.

As an example, the controller 130 may identify a target space with the smallest arrival time and the largest size among a plurality of target spaces (e.g., the at least one target space) as a specified target space. The controller 130 may identify, for example, a target space with the smallest arrival time as the specified target space, without regard to the size (or length or width) of the target space depending on a situation. The controller 130 may identify, for example, the target space with the largest size (or the longest length or width) as the specified target space, without regard to the arrival time depending on the situation.

For example, if the relative position between the host vehicle and the specified target space meets a specified condition, the controller 130 may control the host vehicle to enter the specified target space and make a lane change.

As an example, if one point of the host vehicle (e.g., one point 605 of the front bumper of the host vehicle in FIGS. 6A and 6B overtakes a starting point of the specified target space (e.g., a starting point TL of a specified target space 680 in FIGS. 6A and 6B)) (e.g., in FIG. 6B), the controller 130 may control the host vehicle to enter the specified target space and make a lane change.

As an example, if the one point of the host vehicle (e.g., the one point 605 of the front bumper of the host vehicle in FIGS. 6A and 6B does not overtake the starting point of the specified target space (e.g., the starting point TL of the specified target space 680 in FIGS. 6A and 6B)) (e.g., in FIG. 6A), the controller 130 may control the host vehicle to perform biased driving to be adjacent to the adjacent lane. Furthermore, the controller 130 may adjust the driving speed of the host vehicle, such that the host vehicle follows the specified target space. At this time, only if the size of the specified target space is less than or equal to a specified size, the controller 130 may perform biased driving control.

A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

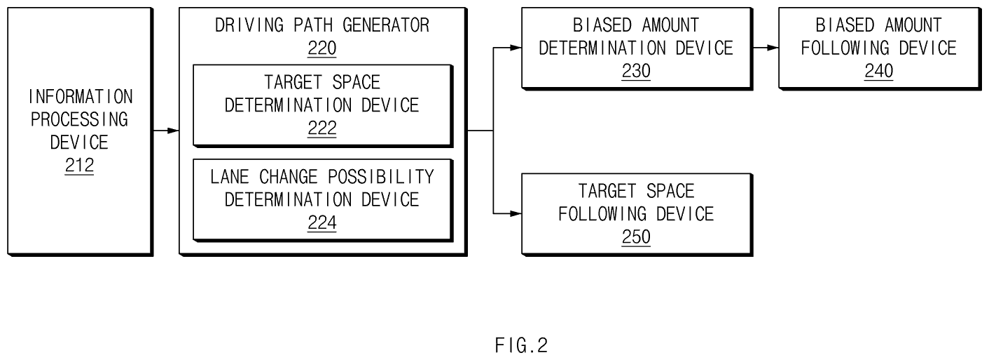

FIG. 2 shows an example of components and an operation of a vehicle control apparatus according to an example of the present disclosure.

According to an example, a vehicle control apparatus (e.g., a vehicle control apparatus 100 of FIG. 1) may include an information processing device 212, a driving path generator 220, a biased amount determination device 230, a biased amount following device 240, and a target space following device 250. For example, the information processing device 212, the driving path generator 220, the biased amount determination device 230, the biased amount following device 240, and the target space following device 250 may be implemented as one device (e.g., a controller 130 of FIG. 1). For example, the driving path generator 220 may include a target space determination device 222 and a lane change possibility determination device 224.

For example, the information processing device 212 may process and obtain pieces of information used to determine whether to perform driving control based on any item among biased driving control for the host vehicle, lane keeping control for the host vehicle, or lane change control for the host vehicle.

As an example, the information processing device 212 may obtain, process, and determine information about a driving speed of the host vehicle, information about whether there is a need to make a lane change, information about whether it is possible to make a lane change, surrounding object information (e.g., information about the at least one other vehicle), information about a speed limit event (e.g., speed limit information of the lane, curvature speed information of the lane, or the like), information about the target space for a lane change, or information about a distance in which it is possible to make a lane change (e.g., a range in which it is possible to make a lane change depending on regulations).

As an example, the information processing device 212 may determine whether there is a need to perform lane change control for the host vehicle based on at least some of the pieces of processed information.

For example, the target space determination device 222 may determine (or predict) a target space in which the host vehicle will be located assuming that the host vehicle makes a lane change. As an example, the target space determination device 222 may determine at least one target space for a lane change. The at least one target space may include a portion of a space between the at least one other vehicle which is traveling in the adjacent lane. The target space determination device 222 may identify a space except for a front margin and a rear margin for each of the at least one other vehicle as the at least one target space.

For example, the lane change possibility determination device 224 may identify a specified target space in which it is possible to make a lane change among the at least one target space, based on an expected speed trajectory and a size of each of the at least one target space. At this time, the lane change possibility determination device 224 may identify the specified target space based on an arrival time expected to arrive at each of the at least one target space and the size of each of the at least one target space at an arrival time point, based on the expected speed trajectory.

For example, if it is determined that it is impossible to make the lane change (or if it is determined that there is a need to first perform biased driving control), the biased amount determination device 230 may determine an amount of biased control for controlling the host vehicle to travel close to the adjacent lane. As an example, the biased amount determination device 230 may determine an amount of biased control based on line information about the lane and the adjacent lane, a speed trajectory of the host vehicle, a width of the host vehicle, a width of lane, a size of the target space, a lane change possibility range, or the like.

For example, the biased amount following device 240 may perform biased driving control for the host vehicle, based on the amount of biased control determined by means of the biased amount determination device 230.

For example, if the specified target space in which it is possible to make the lane change is identified by means of the driving path generator 220, the target space following device 250 may control the host vehicle to enter the specified target space. As a result, the lane change control for the host vehicle may be completed.

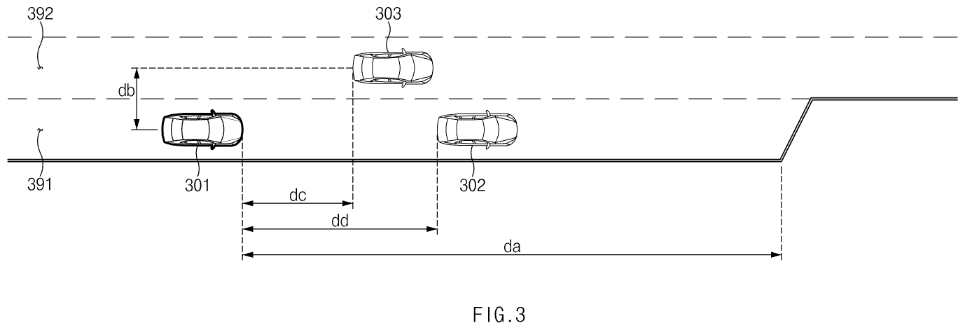

FIG. 3 shows an example of a situation in which a host vehicle is traveling according to an example of the present disclosure.

According to an example, a vehicle control apparatus (e.g., a vehicle control apparatus 100 of FIG. 1) may obtain information about a host vehicle 301 and an object around the host vehicle 301.

For example, the vehicle control apparatus may identify information about the host vehicle 301 and a first other vehicle 302, which are traveling in a lane 391

As an example, the vehicle control apparatus may identify a separation distance dd between the host vehicle 301 and the first other vehicle 302. As an example, the vehicle control apparatus may identify a lane change possibility distance da from a current position of the host vehicle 301 to a point at which the lane 391 is ended.

For example, the vehicle control apparatus may identify information about the host vehicle 301 and a second other vehicle 303 which is traveling in an adjacent lane 392.

As an example, the vehicle control apparatus may identify a lateral distance db and a longitudinal distance dc between the host vehicle 301 and the second other vehicle 303.

For example, the vehicle control apparatus may identify a target space based on the pieces of obtained information. A description of identifying the target space may be referenced in detail in a description of FIG. 4, which will be described below.

FIG. 4 shows an example of an operation of identifying a target space in a vehicle control apparatus according to an example of the present disclosure.

According to an example, a vehicle control apparatus (e.g., a vehicle control apparatus 100 of FIG. 1) may obtain information about a host vehicle 401 and an object around the host vehicle 401.

For example, the vehicle control apparatus may identify information about a lane 491 in which the host vehicle 401 is traveling. As an example, the vehicle control apparatus may identify information about a first other vehicle 410 which is traveling in the lane 491. As an example, if identifying that there is an end point 499 at which the lane is ended within a specified distance of the lane 491 from a current position of the host vehicle 401, the vehicle control apparatus may determine that there is a need to make a lane change and may identify at least one target space (481 and 482).

For example, the vehicle control apparatus may identify information about at least one other vehicle (420, 430, and 440) which is traveling in an adjacent lane 492 which is a target of a lane change and front margins 422, 432, and 442 and rear margins 421, 431, and 441 of the at least one other vehicle (420, 430, and 440).

For example, the vehicle control apparatus may identify a front margin and a rear margin of the other vehicle, based on the following equations, but a margin identification method according to the equations is exemplary and examples of the present disclosure are not limited thereto.

$$Front margin = max ( speed of other v ehicle - speed of host vehicle , 0 ) * P 1 + \frac{\begin{matrix}max ( speed of other vehicle - \\ {speed of host vehicle , 0 )}^{2}\end{matrix}}{2 * P 2} + speed of other vehicle * P 3 + length of host vehicle + length of another vehicle \qquad [ Equation 1 ]$$

For example, the front margin of the other vehicle may be calculated as Equation 1 above using a larger value between a difference between the speed of the other vehicle and the speed of the host vehicle and “0”, the speed of the other vehicle, and lengths of the host vehicle and the other vehicle. The front margin may be a parameter indicating a distance from a specified first point of the other vehicle (e.g., one point of the front bumper of the other vehicle). As an example, P1, P2, and P3 may be random constants capable of being changed by a setting of a user.

$$Rear margin = max ( \text{} speed of host vehicle - speed of other vehicle , 0 ) * P 3 + \frac{{max ( speed of host vehicle - speed of other vehicle , 0 )}^{2}}{2 * P 5} + speed of host vehicle * P 6 \qquad [ Equation 2 ]$$

For example, the rear margin of the other vehicle may be calculated as Equation 2 above using a larger value between a difference between the speed of the other vehicle and the speed of the host vehicle and “0” and the speed of the other vehicle. The rear margin may be a parameter indicating a distance from a specified second point of the other vehicle (e.g., one point of the rear bumper of the other vehicle). As an example, P4, P5, and P6 may be random constants capable of being changed by a setting of the user.

As an example, the vehicle control apparatus may identify second margins 421 and 422 corresponding to the second other vehicle 420. The second margins 421 and 422 may include the second rear margin 421 including a rear area of the second other vehicle 420 and the second front margin 422 including a front area of the second other vehicle 420.

As an example, the vehicle control apparatus may identify third margins 431 and 432 corresponding to the third other vehicle 430. The third margins 431 and 432 may include the third rear margin 431 including a rear area of the third other vehicle 430 and the third front margin 432 including a front area of the third other vehicle 430.

As an example, the vehicle control apparatus may identify fourth margins 441 and 442 corresponding to the fourth other vehicle 440. The fourth margins 441 and 442 may include the fourth rear margin 441 including a rear area of the fourth other vehicle 440 and the fourth front margin 442 including a front area of the fourth other vehicle 440.

For example, the vehicle control apparatus may identify the at least one target space (481 and 482) between the at least one other vehicle.

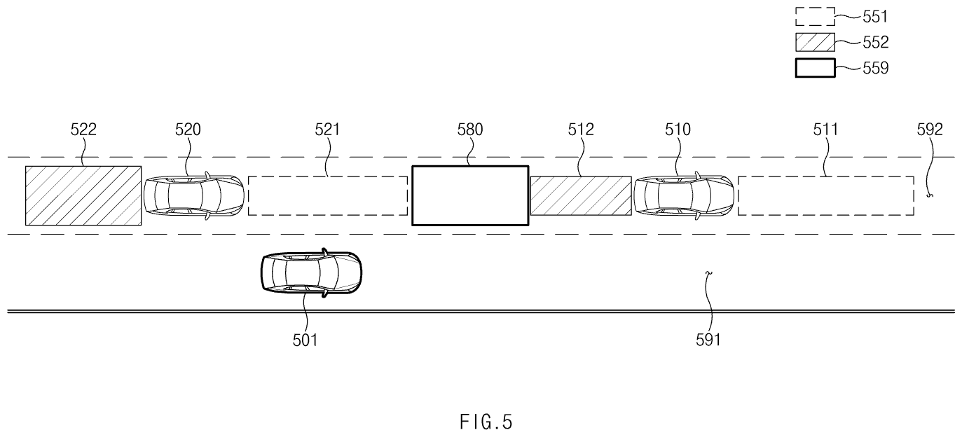

FIG. 5 shows an example of an operation of identifying a target space in a vehicle control apparatus according to an example of the present disclosure.

According to an example, a vehicle control apparatus (e.g., a vehicle control apparatus 100 of FIG. 1) may obtain information about a host vehicle 501 and an object around the host vehicle 501.

For example, the vehicle control apparatus may identify information about at least one other vehicle (510 and 520) which is traveling in an adjacent lane 592 which is a target of a lane change and a front margin 551 and a rear margin 552 of the at least one other vehicle (510 and 520).

As an example, the vehicle control apparatus may identify first margins 511 and 512 corresponding to the first other vehicle 510. The first margins 511 and 512 may include the first front margin 511 including a space from a specific point (e.g., one point of the front bumper) in front of the first other vehicle 510 and the first rear margin 512 including a space from a specific point (e.g., one point of the rear bumper) behind the first other vehicle 510.

As an example, the vehicle control apparatus may identify second margins 521 and 522 corresponding to the second other vehicle 520. The second margins 521 and 522 may include the second front margin 521 including a space from a specific point (e.g., one point of the front bumper) in front of the second other vehicle 520 and the second rear margin 522 including a space from a specific point (e.g., one point of the rear bumper) behind the second other vehicle 520.

For example, if identifying a situation in which there is a need to perform lane change control from a lane 591 to an adjacent lane 592, the vehicle control apparatus may identify at least one target space 559 using a margin of the at least one other vehicle (510 and 520) in the adjacent lane 592.

As an example, the vehicle control apparatus may identify a space between the first rear margin 512 of the first other vehicle 510 which is traveling in front of the host vehicle 501 and the second front margin 521 of the second other vehicle 520 which is traveling behind the host vehicle 501 as a target space 580.

Although not shown, the vehicle control apparatus may further identify the at least one target space 559 using the first front margin 511 of the first other vehicle 510 and/or the second rear margin 522 of the second other vehicle 520. As an example, if the first other vehicle 510 is a frontmost vehicle, the vehicle control apparatus may identify the entire space after the first front margin 511 as the at least one target space 559. As an example, if the second other vehicle 520 is a rearmost vehicle, the vehicle control apparatus may identify the entire space before the second rear margin 522 as the at least one target space 559.

Herein, in a description of FIGS. 6A and 6B, if a specified target space 680 is identified, a description will be given of a situation in which the vehicle control apparatus (e.g., the vehicle control apparatus 100 of FIG. 1) makes a lane change or does not make the lane change, based on whether a relative position between a host vehicle 601 and the specified target space 680 meets a condition.

FIGS. 6A and 6B are conceptual diagrams illustrating a situation in which a vehicle control apparatus determines a condition for making a lane change according to an example of the present disclosure.

According to an example, a vehicle control apparatus (e.g., a vehicle control apparatus 100 of FIG. 1) may obtain information about a host vehicle 601 and an object around the host vehicle 601.

For example, the vehicle control apparatus may identify information about at least one other vehicle (610 and 620) which is traveling in an adjacent lane 692 which is a target of a lane change and a front margin a rear margin of the at least one other vehicle (610 and 620).

As an example, the vehicle control apparatus may identify first margins 611 and 612 corresponding to the first other vehicle 610. The first margins 611 and 612 may include the first front margin 611 including a space from a specific point (e.g., one point of the front bumper) in front of the first other vehicle 610 and the first rear margin 612 including a space from a specific point (e.g., one point of the rear bumper) behind the first other vehicle 610.

As an example, the vehicle control apparatus may identify second margins 621 and 622 corresponding to the second other vehicle 620. The second margins 621 and 622 may include the second front margin 621 including a space from a specific point (e.g., one point of the front bumper) in front of the second other vehicle 620 and the second rear margin 612 including a space from a specific point (e.g., one point of the rear bumper) behind the second other vehicle 620.

For example, the vehicle control apparatus may identify at least one target space, including a specified target space 680 shown in FIG. 6A. Thereafter, the vehicle control apparatus may identify a target space with the smallest arrival time and/or the largest size (or length) among the at least one target space as the specified target space 680.

As an example, the size of the specified target space 680 may indicate a longitudinal length DT of the specified target space 680 with respect to a top view. In other words, the vehicle control apparatus may identify a target space with the longest length DT among the at least one target space as the specified target space 680.

As shown in FIG. 6A, if one point 605 of the host vehicle 601 does not overtake a starting point TL of the specified target space 680 (or if the one point 605 is located before the starting point TL), the vehicle control apparatus may control the host vehicle 601 to perform biased driving to be adjacent to the adjacent lane 692.

As shown in FIG. 6B, if the one point 605 of the host vehicle 601 overtakes the starting point TL of the specified target space 680 (or if the one point 605 is located after the starting point TL), the vehicle control apparatus may control the host vehicle 601 to enter the specified target space 680 and make a lane change.

In other words, if the one point 605 of the host vehicle 601 overtakes the starting point TL of the specified target space 680 or at least a part of the body of the host vehicle 601 deviates from a margin immediately before the specified target space 680 (or the second front margin 621 of FIGS. 6A and 6B), the vehicle control apparatus may control the host vehicle 601 to enter the specified target space 680, thus performing lane change control for the host vehicle 601.

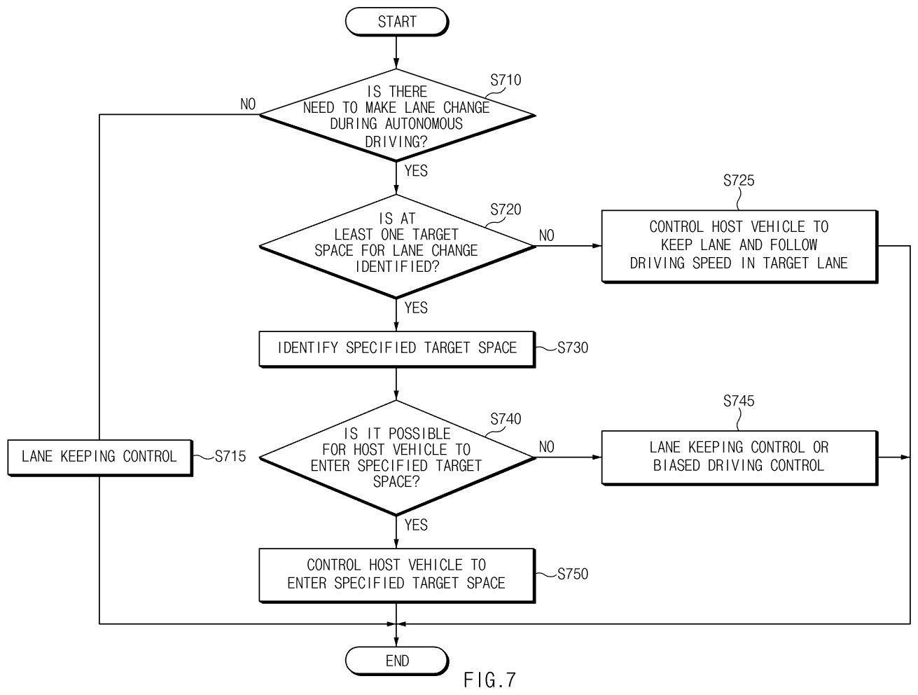

FIG. 7 shows an example of a vehicle control method according to an example of the present disclosure. For convenience, FIG. 7 is described by way of an example in which the steps are performed by a vehicle control apparatus 100 of FIG. 1 (e.g., processor circuitry). One, some, or all steps of the example method of FIG. 7, or portions thereof, may be performed by one or more other circuits. One or some, steps of the example method of FIG. 7 may be omitted, performed in other orders, and/or otherwise modified, and/or one or more additional steps may be added.

For example, at least some of components (e.g., a sensor device 110, a memory 120, and/or a controller 130 of FIG. 1) included in the vehicle control apparatus may be configured to perform operations of FIG. 7.

Operations in S710 to S750 in an example below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 7, may be briefly described or omitted.

According to an example, in S710, the vehicle control apparatus may identify whether there is a need to make a lane change during autonomous driving.

For example, the vehicle control apparatus may identify whether there is a need to make a lane change while performing autonomous driving control for a host vehicle.

For example, if there is the need to make the lane change (e.g., S710—YES), the vehicle control apparatus may perform S720.

For example, if there is no need to make the lane change (e.g., S710—NO), the vehicle control apparatus may perform S715.

According to an example, in S715, the vehicle control apparatus may perform lane keeping control.

For example, when identifying or determining that there is no need to make the lane change, the vehicle control apparatus may control the host vehicle to continuously travel in a lane.

According to an example, in S720, the vehicle control apparatus may determine whether a target space for the lane change is identified.

For example, if the target space is identified (e.g., S720—YES), the vehicle control apparatus may perform S730.

For example, if the target space is not identified (e.g., S720—NO), the vehicle control apparatus may perform S725.

According to an example, in S725, the vehicle control apparatus may control the host vehicle to keep the lane and follow a driving speed in a target lane.

For example, if there is the need to make the lane change, but the target space is not identified, the vehicle control apparatus may perform driving control such that the host vehicle follows an average driving speed in an adjacent lane to travel while keeping the lane.

According to an example, in S730, the vehicle control apparatus may identify a specified target space among the identified at least one target space.

For example, the vehicle control apparatus may identify the specified target space based on an arrival time for each of the at least one target space and a size (or length or width) of each of the at least one target space.

According to an example, in S740, the vehicle control apparatus may determine whether it is possible for the host vehicle to enter the specified target space.

For example, the vehicle control apparatus may determine whether it is possible for the host vehicle to enter the specified target space, based on whether a relative position between the host vehicle and the specified target space meets a specified condition. As an example, if one point of the host vehicle (e.g., one point of the front bumper) overtakes a starting point of the specified target space (e.g., a starting point TL in FIGS. 6A and 6B), the vehicle control apparatus may determine that the relative position meets the specified condition.

For example, if it is possible for the host vehicle to enter the specified target space (e.g., S740—YES), the vehicle control apparatus may perform S750.

For example, if it is not possible for the host vehicle to enter the specified target space (e.g., S740—NO), the vehicle control apparatus may perform S745.

According to an example, in S745, the vehicle control apparatus may perform lane keeping control or biased driving control for the host vehicle.

For example, if the size (or length or width) of the specified target space satisfy (e.g., the size is smaller than a specified size or is smaller than a specified length or width) a threshold value, the vehicle control apparatus may perform biased driving control.

According to an example, in S750, the vehicle control apparatus may control the host vehicle to enter the specified target space.

For example, the vehicle control apparatus may control the host vehicle to enter the specified target space, thus completing lane change control.

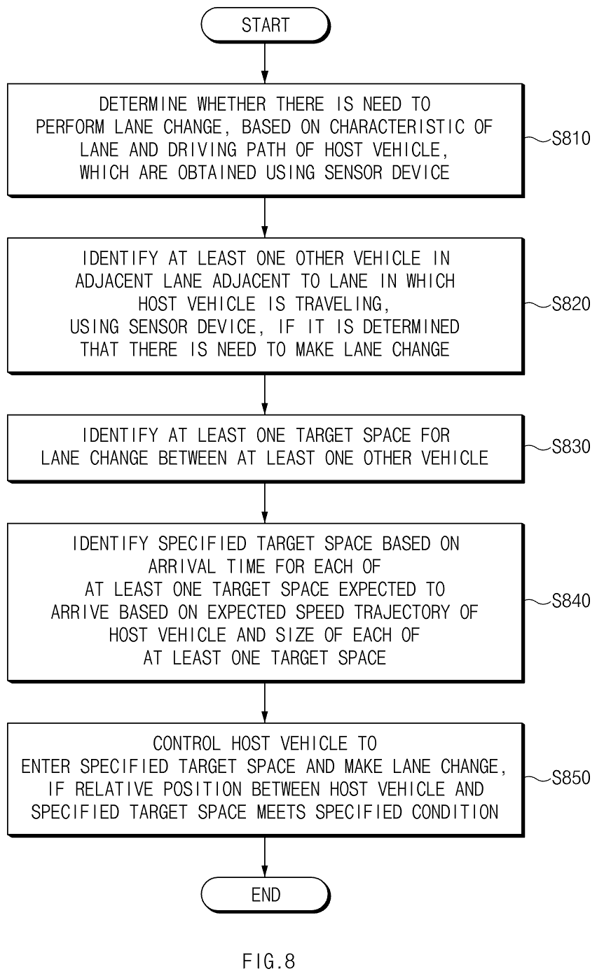

FIG. 8 shows an example of a vehicle control method according to an example of the present disclosure.

According to an example, a vehicle control apparatus (e.g., a vehicle control apparatus 100 of FIG. 1) may perform operations disclosed in FIG. 8. For example, at least some of components (e.g., a sensor device 110, a memory 120, and/or a controller 130 of FIG. 1) included in the vehicle control apparatus may be configured to perform operations of FIG. 8. One, some, or all steps of the example method of FIG. 8, or portions thereof, may be performed by one or more other circuits. One or some, steps of the example method of FIG. 8 may be omitted, performed in other orders, and/or otherwise modified, and/or one or more additional steps may be added.

Operations in S810 to S850 in an example below may be sequentially performed, but are not necessarily sequentially performed. For example, an order of the respective operations may be changed, and at least two operations may be performed in parallel. Furthermore, contents, which correspond to or are duplicated with the contents described above in conjunction with FIG. 8, may be briefly described or omitted.

According to an example, in S810, the vehicle control apparatus may determine whether there is a need to make a lane change, based on a characteristic of a lane and a driving path of the host vehicle, which are obtained using a sensor device.

According to an example, in S820, the vehicle control apparatus may identify at least one other vehicle in an adjacent lane adjacent to the lane in which the host vehicle is traveling, using the sensor device, if it is determined that there is the need to make the lane change.

According to an example, in S830, the vehicle control apparatus may identify at least one target space for the lane change between the at least one other vehicle.

According to an example, example, in S840, the vehicle control apparatus may identify a specified target space based on an arrival time for each of the at least one target space expected to arrive based on an expected speed trajectory of the host vehicle and a size of each of the at least one target space.

According to an example, in S850, the vehicle control apparatus may control the host vehicle to enter the specified target space and make the lane change, if a relative position between the host vehicle and the specified target space meets or satisfies a specified condition (e.g., the host vehicle being aligned within a lane, within safe stopping distance, parallel to a parking space, clear of obstacles, at a safe distance for a lane change, at a safe angle, within overtaking range, properly aligned for reversing, near a stop line, or positioned near a charging station, etc.).

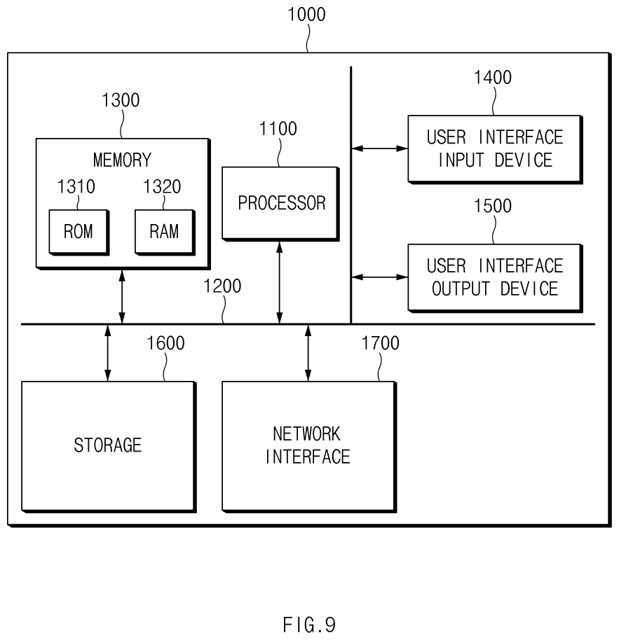

FIG. 9 shows an example of a computing system about a vehicle control apparatus or a vehicle control method according to an example of the present disclosure.

Referring to FIG. 9, a computing system 1000 about the vehicle control apparatus or the vehicle control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present disclosure has been made to solve the above-mentioned problems occurring in the prior art while advantages achieved by the prior art are maintained intact.

An example of the present disclosure provides a vehicle control apparatus for first identifying target space candidate groups for a lane change, if it is identified that it is impossible to immediately make the lane change, in a situation in which there is a need to make the lane change, and safely and quickly making the lane change using positions and/or driving speeds of the host vehicle and at least one other vehicle and a method thereof.

Another example of the present disclosure provides a vehicle control apparatus for providing a lane change function for selecting a target space using a front margin or a rear margin corresponding to each of at least one other vehicle to prevent collision with the other vehicle and allow a host vehicle to enter a safe space and a method thereof.

Another example of the present disclosure provides a vehicle control apparatus for immediately making a lane change, only if one point (e.g., a front bumper) of a host vehicle overtakes a starting point of a target space, and performing biased driving control, if the one point of the host vehicle does not overtake the starting point of the target space and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a sensor device, a memory storing at least one instruction, and a controller operatively connected with the sensor device and the memory. For example, the at least one instruction may be configured to, when executed by the controller, cause the vehicle control apparatus to determine whether there is a need to make a lane change, based on a characteristic of a lane and a driving path of a host vehicle, the characteristic and the driving path being obtained using the sensor device, identify at least one other vehicle in an adjacent lane adjacent to the lane in which the host vehicle is traveling, using the sensor device, if it is determined that there is the need to make the lane change, identify at least one target space for the lane change between the at least one other vehicle, identify a specified target space based on an arrival time for each of the at least one target space expected to arrive based on an expected speed trajectory of the host vehicle and a size of each of the at least one target space, and control the host vehicle to enter the specified target space and make the lane change, if a relative position between the host vehicle and the specified target space meets a specified condition.

According to an example, the at least one instruction may be configured to, when executed by the controller, cause the vehicle control apparatus to determine that there is the need to make the lane change, if there is a point at which the lane is ended within a specified distance of the lane or identifying a situation of having to travel in the adjacent lane based on the driving path.

According to an example, the at least one instruction may be configured to, when executed by the controller, cause the vehicle control apparatus to identify an average driving speed of the at least one other vehicle, using the sensor device, and identify the at least one target space, if a difference between the average driving speed and a driving speed of the host vehicle is less than or equal to a specified speed.

According to an example, the at least one instruction may be configured to, when executed by the controller, cause the vehicle control apparatus to identify an average driving speed of the at least one other vehicle, using the sensor device, and adjust a driving speed of the host vehicle to follow the average driving speed, if a difference between the average driving speed and the driving speed of the host vehicle is greater than a specified speed.

According to an example, the at least one instruction may be configured to, when executed by the controller, cause the vehicle control apparatus to identify the expected speed trajectory based on acceleration control or deceleration control for the host vehicle and identify the arrival time expected to arrive at each of the at least one target space and the size of each of the at least one target space at an arrival time point, based on the expected speed trajectory.

According to an example, the at least one instruction may be configured to, when executed by the controller, cause the vehicle control apparatus to identify the expected speed trajectory using at least one of a distance to a point at which the lane is ended, a driving speed limit in the lane and the adjacent lane, a user input speed, or a separation distance between the host vehicle and a forward other vehicle, or any combination thereof.

According to an example, the at least one instruction may be configured to, when executed by the controller, cause the vehicle control apparatus to identify a first driving speed of a first other vehicle which is present in front of the host vehicle among the at least one other vehicle and a second driving speed of a second other vehicle which is present behind the host vehicle among the at least one other vehicle, using the sensor device, identify a rear margin of the first other vehicle using the first driving speed and a driving speed of the host vehicle, identify a front margin of the second other vehicle using the second driving speed, the driving speed of the host vehicle, and lengths of the host vehicle and the second other vehicle, and identify a space between the rear margin and the front margin as one of the at least one target space.

According to an example, the at least one instruction may be configured to, when executed by the controller, cause the vehicle control apparatus to identify a target space with a smallest arrival time and a largest size among the at least one target space as the specified target space.

According to an example, the at least one instruction may be configured to, when executed by the controller, cause the vehicle control apparatus to control the host vehicle to enter the specified target space and make the lane change, if one point of the host vehicle overtakes a starting point of the specified target space.

According to an example, the at least one instruction may be configured to, when executed by the controller, cause the vehicle control apparatus to control the host vehicle to perform biased driving to be adjacent to the adjacent lane, if one point of the host vehicle does not overtake a starting point of the specified target space.

According to another example of the present disclosure, a vehicle control method may include determining, by a controller, whether there is a need to make a lane change, based on a characteristic of a lane and a driving path of a host vehicle, the characteristic and the driving path being obtained using a sensor device, identifying, by the controller, at least one other vehicle in an adjacent lane adjacent to the lane in which the host vehicle is traveling, using the sensor device, if it is determined that there is the need to make the lane change, identifying, by the controller, at least one target space for the lane change between the at least one other vehicle, identifying, by the controller, a specified target space based on an arrival time for each of the at least one target space expected to arrive based on an expected speed trajectory of the host vehicle and a size of each of the at least one target space, and controlling, by the controller, the host vehicle to enter the specified target space and make the lane change, if a relative position between the host vehicle and the specified target space meets a specified condition.

According to an example, the vehicle control method may further include determining, by the controller, that there is the need to make the lane change, if there is a point at which the lane is ended within a specified distance of the lane or identifying a situation of having to travel in the adjacent lane based on the driving path.

According to an example, the vehicle control method may further include identifying, by the controller, an average driving speed of the at least one other, using the sensor device, and identifying, by the controller, the at least one target space, if a difference between the average driving speed and a driving speed of the host vehicle is less than or equal to a specified speed.

According to an example, the vehicle control method may further include identifying, by the controller, an average driving speed of the at least one other, using the sensor device, and adjusting, by the controller, a driving speed of the host vehicle to follow the average driving speed, if a difference between the average driving speed and the driving speed of the host vehicle is greater than a specified speed.

According to an example, the vehicle control method may further include identifying, by the controller, the expected speed trajectory based on acceleration control or deceleration control for the host vehicle and identifying, by the controller, the arrival time expected to arrive at each of the at least one target space and the size of each of the at least one target space at an arrival time point, based on the expected speed trajectory.

According to an example, the vehicle control method may further include identifying, by the controller, the expected speed trajectory using at least one of a distance to a point at which the lane is ended, a driving speed limit in the lane and the adjacent lane, a user input speed, or a separation distance between the host vehicle and a forward other vehicle, or any combination thereof.

According to an example, the vehicle control method may further include identifying, by the controller, a first driving speed of a first other vehicle which is present in front of the host vehicle among the at least one other vehicle and a second driving speed of a second other vehicle which is present behind the host vehicle among the at least one other vehicle, using the sensor device, identifying, by the controller, a rear margin of the first other vehicle using the first driving speed and a driving speed of the host vehicle, identifying a front margin of the second other vehicle using the second driving speed, the driving speed of the host vehicle, and lengths of the host vehicle and the second other vehicle, and identifying, by the controller, a space between the rear margin and the front margin as one of the at least one target space.

According to an example, the vehicle control method may further include identifying, by the controller, a target space with a smallest arrival time and a largest size among the at least one target space as the specified target space.

According to an example, the vehicle control method may further include controlling, by the controller, the host vehicle to enter the specified target space and make the lane change, if one point of the host vehicle overtakes a starting point of the specified target space.

According to an example, the vehicle control method may further include controlling, by the controller, the host vehicle to perform biased driving to be adjacent to the adjacent lane, if one point of the host vehicle does not overtake a starting point of the specified target space.

A description will be given of effects of the vehicle control apparatus and the method thereof according to an example of the present disclosure.

Examples of the present disclosure may first identify target space candidate groups for a lane change, if it is identified that it is impossible to immediately make the lane change, in a situation in which there is a need to make the lane change, and safely and quickly make the lane change using positions and/or driving speeds of the host vehicle and at least one other vehicle.

Examples of the present disclosure may provide a lane change function for selecting a target space using a front margin or a rear margin corresponding to each of at least one other vehicle to prevent collision with the other vehicle and allow the host vehicle to enter a safe space.

Examples of the present disclosure may immediately make a lane change, only if one point (e.g., a front bumper) of the host vehicle overtakes a starting point of the target space, and may perform biased driving control, if the one point of the host vehicle does not overtake the starting point of the target space.

In addition or alternative, various effects ascertained directly or indirectly through the present disclosure may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for examples. The scope of the present disclosure should be construed on the basis of the accompanying claims, and all the technical ideas within the scope equivalent to the claims should be included in the scope of the present disclosure.

What is claimed is:

1. An apparatus for controlling a vehicle, the apparatus comprising:
a sensor;
a memory storing at least one instruction; and
a processor operatively coupled to the sensor and the memory,
wherein the at least one instruction, when executed by the processor is configured to cause the apparatus to:
determine, based on a characteristic of a lane and a driving path of the vehicle, whether to make a lane change, wherein the characteristic and the driving path are obtained using the sensor;
based on a determination to make the lane change, detect, using the sensor, at least one other vehicle in a second lane adjacent to a first lane in which the vehicle is traveling;
determine at least one target space between the vehicle and the at least one other vehicle for the lane change;
determine, based on at least one arrival time, a specified target space of the at least one target space, wherein each arrival time of the at least one arrival time is an expected time for the vehicle to arrive at a respective target space of the at least one target space, and wherein the expected time is determined based on an expected speed trajectory of the vehicle and a size of the respective target space of the at least one target space; and
control, based on a relative position between the vehicle and the specified target space satisfying a condition, the vehicle to enter the specified target space and make the lane change.

2. The apparatus of claim 1, wherein the at least one instruction, when executed by the processor, is configured to cause the apparatus to:
based on a presence of a point at which the first lane is ended within a specified distance of the first lane or based on a detected event that requires the vehicle to travel in the second lane, determine to make the lane change.

3. The apparatus of claim 1, wherein the at least one instruction, when executed by the processor, is configured to cause the apparatus to:
determine, using the sensor, an average driving speed of the at least one other vehicle; and
determine, based on a difference between the average driving speed and a driving speed of the vehicle being less than or equal to a specified speed, the at least one target space.

4. The apparatus of claim 1, wherein the at least one instruction is, when executed by the processor, is configured to cause the apparatus to:
determine, using the sensor, an average driving speed of the at least one other vehicle; and
adjust, based on a difference between the average driving speed and a driving speed of the vehicle being greater than a specified speed, the driving speed of the vehicle to follow the average driving speed.

5. The apparatus of claim 1, wherein the at least one instruction, when executed by the processor, is configured to cause the apparatus to:
determine, based on acceleration control or deceleration control for the vehicle, the expected speed trajectory; and
determine, based on the expected speed trajectory, one of the at least one arrival time and the size of the specified target space at an arrival time point.

6. The apparatus of claim 5, wherein the at least one instruction is, when executed by the processor, is configured to cause the apparatus to:
determine the expected speed trajectory based on at least one of:
a distance to a point at which the first lane is ended,
a first driving speed limit in the first lane and a second driving speed limit in the second lane,
a user input speed, or
a separation distance between the vehicle and another vehicle.

7. The apparatus of claim 1, wherein the at least one instruction, when executed by the processor, is configured to cause the apparatus to:
determine, using the sensor, a first driving speed of a first other vehicle which is present in front of the vehicle and a second driving speed of a second other vehicle which is present behind the vehicle;
determine, based on the first driving speed and a driving speed of the vehicle, a rear margin of the first other vehicle;
determine, based on the second driving speed, the driving speed of the vehicle, and a first length of the vehicle, and a second length of the second other vehicle, a front margin of the second other vehicle; and
determine a space between the rear margin and the front margin as one of the at least one target space.

8. The apparatus of claim 1, wherein the at least one instruction, when executed by the processor, is configured to cause the apparatus to:
determine a target space with a smallest arrival time and a largest size among a plurality of target spaces as the specified target space.

9. The apparatus of claim 1, wherein the at least one instruction, when executed by the processor, is configured to cause the apparatus to:
control, based on one point of the vehicle overtaking a starting point of the specified target space, the vehicle to enter the specified target space and make the lane change.

10. The apparatus of claim 1, wherein the at least one instruction, when executed by the processor, is configured to cause the apparatus to:
control, based on one point of the vehicle not overtaking a starting point of the specified target space, the vehicle to perform biased driving to be adjacent to the second lane.

11. A method performed by an apparatus of a vehicle for controlling the vehicle, the method comprising:
determining, based on a characteristic of a lane and a driving path of the vehicle, whether to make a lane change, wherein the characteristic and the driving path are obtained using a sensor;
based on a determination to make the lane change, detecting, using the sensor, at least one other vehicle in a second lane adjacent to a first lane in which the vehicle is traveling;
determining at least one target space between the vehicle and the at least one other vehicle for the lane change;
determining, based on at least one arrival time, a specified target space of the at least one target space, wherein each arrival time of the at least one arrival time is an expected time for the vehicle to arrive at a respective target space of the at least one target space, and wherein the expected time is determined based on an expected speed trajectory of the vehicle and a size of the respective target space of the at least one target space; and
controlling, based on a relative position between the vehicle and the specified target space satisfying a specified condition, the vehicle to enter the specified target space and make the lane change.

12. The method of claim 11, further comprising:
based on a presence of a point at which the first lane is ended within a specified distance of the first lane or based on a detected event that requires the vehicle to travel in the second lane, determining to make the lane change.

13. The method of claim 11, further comprising:
determining, using the sensor, an average driving speed of the at least one other vehicle; and
determining, based on a difference between the average driving speed and a driving speed of the vehicle being less than or equal to a specified speed, the at least one target space.

14. The method of claim 11, further comprising:
determining, using the sensor, an average driving speed of the at least one other vehicle; and
adjusting, based on a difference between the average driving speed and a driving speed of the vehicle being greater than a specified speed, the driving speed of the vehicle to follow the average driving speed.

15. The method of claim 11, further comprising:
determining, based on acceleration control or deceleration control for the vehicle, the expected speed trajectory; and
determining, based on the expected speed trajectory, one of the at least one arrival time and the size of the specified target space at an arrival time point.

16. The method of claim 15, further comprising:
determining the expected speed trajectory based on at least one of:
a distance to a point at which the first lane is ended,
a first driving speed limit in the first lane and a second driving speed limit in the second lane,
a user input speed, or
a separation distance between the vehicle and another vehicle.

17. The method of claim 11, further comprising:
determining, using the sensor, a first driving speed of a first other vehicle which is present in front of the vehicle and a second driving speed of a second other vehicle which is present behind the vehicle;
determining, based on the first driving speed and a driving speed of the vehicle, a rear margin of the first other vehicle;
determining, based on the second driving speed, the driving speed of the vehicle, and a first length of the vehicle and a second length of the second other vehicle, a front margin of the second other vehicle; and
determine a space between the rear margin and the front margin as one of the at least one target space.

18. The method of claim 11, further comprising:
determining a target space with a smallest arrival time and a largest size among a plurality of target spaces as the specified target space.

19. The method of claim 11, further comprising:
controlling, based on one point of the vehicle overtaking a starting point of the specified target space, the vehicle to enter the specified target space and make the lane change.

20. The method of claim 11, further comprising:
controlling, based on one point of the vehicle not overtaking a starting point of the specified target space, the vehicle to perform biased driving to be adjacent to the second lane.
